(19) United States
(12) Patent Application Publication
(10) Pub. No.: US 2010/0226676 A1
(43) Pub. Date: Sep. 9, 2010

(54) Image forming apparatus

(75) Inventors: Noriaki Funamoto, Tokyo (JP); Yasuhisa Ehara, Kanagawa (JP); Tetsuji Nishikawa, Tokyo (JP); Yasuhiro Maehata, Kanagawa (JP); Jun Yasuda, Chiba (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 12/659,104

(22) Filed: Feb. 25, 2010

(30) Foreign Application Priority Data
Mar. 6, 2009 (JP) 2009-053332

(51) Int. Cl. G03G 15/01

(52) U.S. Cl. 399/66; 399/302

(57) ABSTRACT

In an image forming apparatus, a servomotor is used as a shared driving motor. A motor driver includes a gain changing unit that changes proportional gain. When a monochrome mode is selected, a driving control unit sets the proportional gain lower than a value that is set in a color mode.

### CROSS-REFERENCE TO RELATED APPLICATIONS

The present application claims priority to and incorporates by reference the entire contents of Japanese Patent Application No. 2009-053332 filed in Japan on Mar. 6, 2009.

### BACKGROUND OF THE INVENTION

1. Field of the Invention

The present invention relates to an image forming apparatus that detects fluctuation in the moving speed of an intermediate transfer belt and controls the driving speed of a belt driving source on the basis of the detected result.

2. Description of the Related Art

A typical image forming apparatus transfers a yellow (Y) toner image, a cyan (C) toner image, a magenta (M) toner image, and a black (K) toner image from four photosensitive elements for Y, C, M, and K, respectively, to an endless intermediate transfer belt in a superimposed manner, thereby forming a color image. The typical image forming apparatus includes a driving roller that is a driving rotary member. The driving roller is arranged inside the loop of the intermediate transfer belt, pushing it outward to support the intermediate transfer belt. The intermediate transfer belt is rotated by the rotation of the driving roller. With this configuration, when a belt driving motor that drives both the intermediate transfer belt and the driving roller runs at a constant speed and the diameter of the driving roller changes with the passage of time due to temperature change, the moving speed of the intermediate transfer belt changes with the diameter change. This causes misalignment of the toner images (color shift).

An image forming apparatus is known that detects the moving speed of the intermediate transfer belt using a speed detecting unit and adjusts the driving speed of the belt driving motor using the detected result as the feedback so that the intermediate transfer belt rotates at a predetermined target speed (see, for example, Japanese Patent Application Laid-open No. 2004-220006). With this configuration, even if the diameter of the driving roller changes due to temperature change, the intermediate transfer belt can rotate at the target speed.

The inventors of the present invention study an image forming apparatus that can rotate the intermediate transfer belt at the target speed and is configured, from the perspective of cost reduction, to drive both the photosensitive element for K and the intermediate transfer belt using the same driving motor. The inventors found while conducting experiments that the image forming apparatus having the above-described configuration forms a distorted monochrome image in the monochrome mode. In the monochrome mode, a typical image forming apparatus moves the photosensitive elements for Y, C, and M away from the intermediate transfer belt in order to prevent the photosensitive elements for Y, C, and M and their developing devices, which do not contribute to the image formation, from wearing due to unnecessary operations. When the photosensitive elements for Y, C, and M are not in contact with the intermediate transfer belt, the load to which the driving motor that drives the intermediate transfer belt is subjected decreases and therefore the energy cost can be reduced. A transfer device makes a transfer nip using a transfer roller that comes into contact with the intermediate transfer belt and transfers, when a recording sheet is inserted into the transfer nip, the toner image from the intermediate transfer belt to the recording sheet. When, before the transfer, the leading edge of the recording sheet comes into the transfer nip (hereinafter, “sheet entering time”), the load to which the intermediate transfer belt is subjected increases drastically and therefore the belt moving speed significantly falls for a moment. If an image forming apparatus is configured to detect the fluctuation in the belt moving speed and adjust the driving speed of the driving motor using the feedback, the driving speed of the driving motor increases for the moment due to the decrease in the belt moving speed. As a result, the belt moving speed increases beyond the target speed only for a moment (this phenomenon is called “overshoot”). In the color mode, because all the photosensitive elements for Y, C, M, and K are in contact with the intermediate transfer belt and the load to which the driving motor is subjected is relatively large, the amount of the overshoot is not so large. In the monochrome mode, in contrast, because only the photosensitive element for K is in contact with the intermediate transfer belt and the load to which the driving motor is subjected is relatively small, the amount of the overshoot is large, which results in a distorted image.

Although the problem that occurs in the monochrome mode is described in the above, the same problem occurs in the single-color mode. The single-color mode is a mode in which a driving motor drives both an image carrier for a specific color and the intermediate transfer belt and an image is formed with only the specific color.

### SUMMARY OF THE INVENTION

It is an object of the present invention to at least partially solve the problems in the conventional technology.

According to an aspect of the present invention, there is provided an image forming apparatus including a plurality of image carriers that rotate with different-color visual images carried on their surfaces; a plurality of image-carrier driving sources that drive the image carriers; an intermediate transfer belt that rotates in a state supported by a plurality of supporting members; a driving rotary member that is one of the supporting members and rotates the intermediate transfer belt by rotation thereof; a speed-fluctuation detecting unit that detects fluctuation in moving speed of the intermediate transfer belt; a driving control unit; and a transfer unit that transfers the different-color visual images from the surfaces of the image carriers onto a surface of the intermediate transfer belt and then transfers the transferred image onto a recording sheet, wherein one of the image-carrier driving sources that corresponds to a specific color is a servomotor, and the servomotor also works as a belt driving source that is a driving source of the driving rotary member, the driving control unit controls driving speed of the belt driving source on the basis of a detected result obtained by the speed-fluctuation detecting unit, a driving circuit of the servomotor includes a gain changing unit that changes proportional gain, and when a single-color mode, in which an image is formed with only the specific color, is selected, the driving control unit sets the proportional gain lower than a value that is set in a color mode, in which a full-color image is formed by superimposing a plurality of different-color visual images.

According to another aspect of the present invention, there is provided an image forming apparatus including a plurality of image carriers that rotate with different-color visual images carried on their surfaces; a plurality of image-carrier driving sources that drive the image carriers; an intermediate transfer belt that rotates in a state supported by a plurality of supporting members; a driving rotary member that is one of the supporting members and rotates the intermediate transfer belt by rotation thereof; a speed-fluctuation detecting unit that detects fluctuation in moving speed of the intermediate transfer belt; a driving control unit; and a transfer unit that transfers the different-color visual images from the surfaces of the image carriers onto a surface of the intermediate transfer belt and then transfers the transferred image onto a recording sheet, wherein one of the image-carrier driving sources that corresponds to a specific color is a motor that includes a rotation-signal output unit, and the motor also works as a belt driving source that is a driving source of the driving rotary member, when a color mode, in which a full-color image is formed by superimposing a plurality of different-color visual images, is selected, the driving control unit controls driving speed of the motor on the basis of a detected result obtained by the speed-fluctuation detecting unit, and when a single-color mode, in which an image is formed with only the specific color, is selected, the driving control unit controls the motor on the basis of a rotation signal output from the motor so that the motor runs at a constant angular velocity.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram showing the configuration of a printer according to a first embodiment;

FIG. 2 is an enlarged schematic diagram showing a process unit for Y included in the printer;

FIG. 3 is a perspective view showing the process unit for Y and a photosensitive-element gear for Y that is attached to a main body of the printer;

FIG. 4 is a perspective view showing a transfer unit included in the printer and a motor that drives an intermediate transfer belt;

FIG. 5 is an enlarged perspective view showing the motor and the components nearby;

FIG. 6 is a schematic diagram showing the transfer unit, photosensitive elements for various colors, and gears supported inside the main body of the printer;

FIG. 7 is a schematic diagram showing a driving control unit included in the printer and components that are electrically connected to the driving control unit;

FIG. 8 is a graph that explains a relation between the positional displacements of the belt and the motor at the sheet entering time and the elapsed time when the proportional gain of a motor driver is set relatively high;

FIG. 9 is a graph that explains a relation between the positional displacements of the belt and the motor at the sheet entering time and the elapsed time when the proportional gain of the motor driver is set relatively low; and

FIG. 10 is a schematic diagram showing a driving control unit included in a printer according to a second embodiment of the present invention and components that are electrically connected to the driving control unit.

### DETAILED DESCRIPTION OF THE PREFERRED EMBODIMENTS

An image forming apparatus according to a first embodiment of the present invention is described below. An electrographic printer (hereinafter, simply referred to as a “printer”) is used as the image forming apparatus.

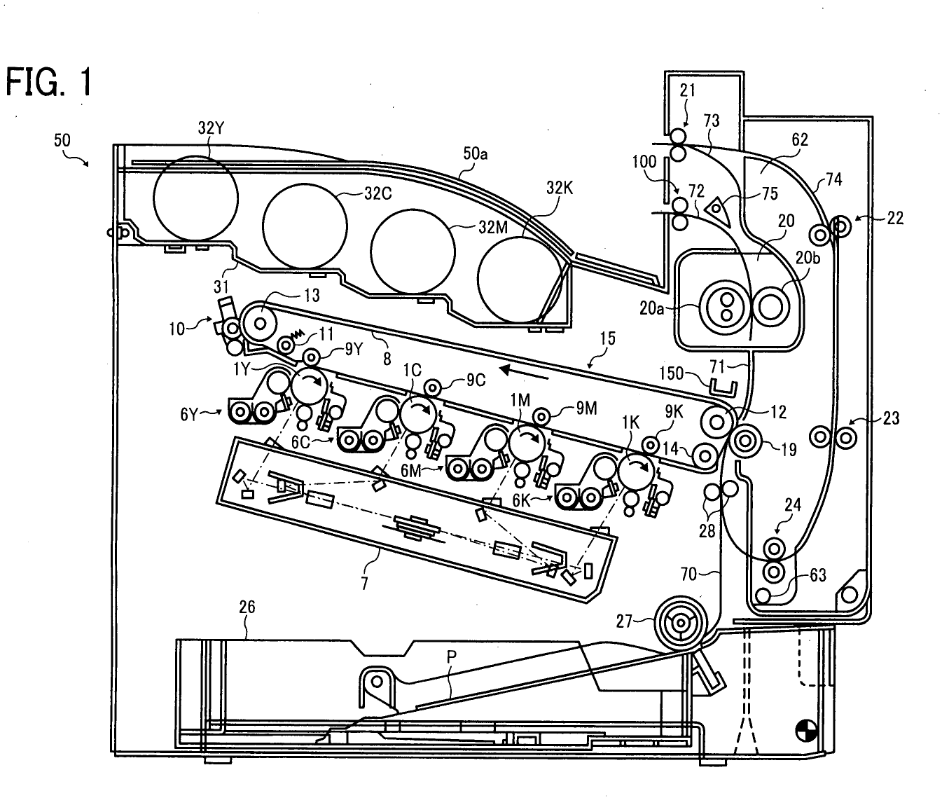

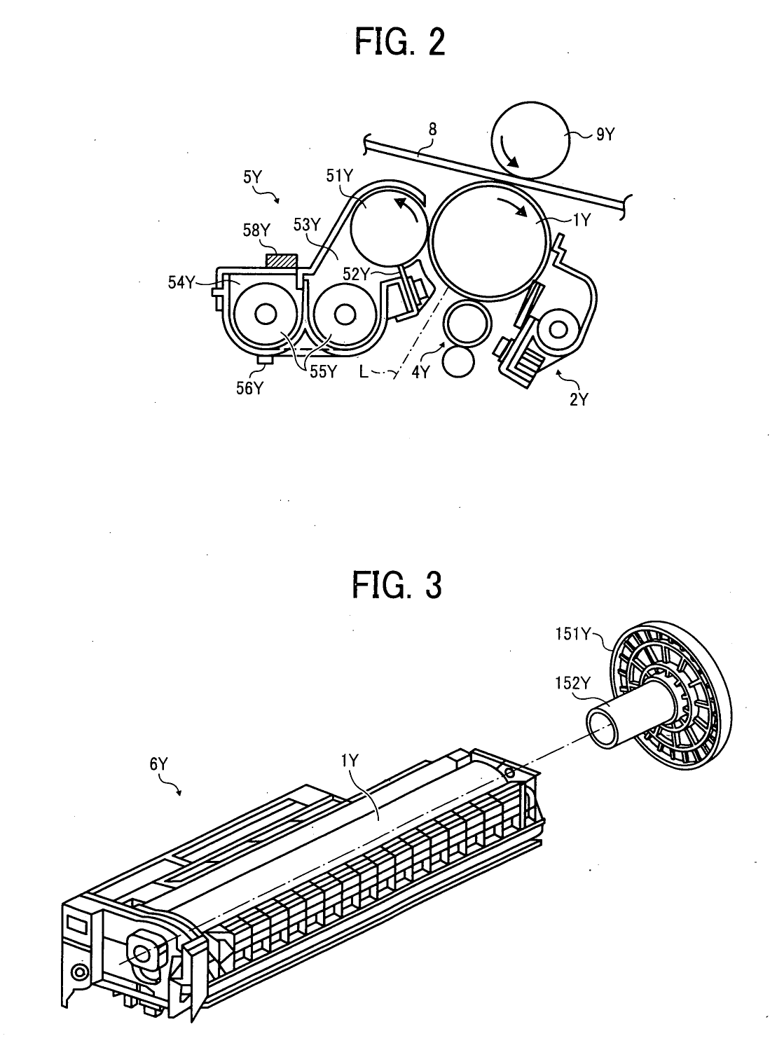

The basic configuration of the printer according to the first embodiment is described below. FIG. 1 is a schematic diagram showing the configuration of the printer according to the first embodiment. As shown in FIG. 1, the printer includes four process units 6Y, 6C, 6M and 6K that form Y, C, M, and K toner images, respectively. The process units 6Y, 6C, 6M and 6K use different color toners, i.e., Y, C, M, and K toners as image forming substances, but otherwise the process units 6Y, 6C, 6M and 6K have the same configuration. The process units 6Y, 6C, 6M and 6K are replaced with new ones when the operating life expires. The process unit 6Y that forms a Y toner image is described in detail below as an example. As shown in FIG. 2, the process unit 6Y includes a drum photosensitive element 1Y that corresponds to an image carrier, a drum cleaning device 2Y, a neutralizing device (not shown), a charging device 4Y, and a developing device 5Y. The process unit 6Y is detachable from a main body of the printer and the consumable components are replaced with new ones at one time.

The charging device 4Y evenly charges the surface of the photosensitive element 1Y that is rotated in the clockwise direction by a driving unit (not shown). The evenly charged surface of the photosensitive element 1Y is exposed to and scanned by a laser light L and a Y electrostatic latent image is formed on the surface. The Y electrostatic latent image is developed into a Y toner image with a Y developer by the developing device 5Y. The Y developer contains Y toners and magnetic carriers. After that, the Y toner image is transferred onto an intermediate transfer belt 8, which is a belt member and will be described in detail later. After the Y toner image is transferred, the drum cleaning device 2Y removes residual toners from the surface of the photosensitive element 1Y. After the cleaning, the neutralizing device neutralizes the surface of the photosensitive element 1Y. The surface of the photosensitive element 1Y is initialized by the neutralization and thus prepared for the next image formation. The other process units 6C, 6M, and 6K form the C, M, and K toner images on their photosensitive elements 1C, 1M, and 1K and transfer the C, M, and K toner images onto the intermediate transfer belt 8 in the same manner.

The developing device 5Y includes a developing roller 51Y and a casing. A part of the developing roller 51Y is exposed through an opening of the casing. The developing device 5Y further includes two conveyer screws 55Y (a first conveyer screw 55Y and a second conveyer screw 55Y) that are arranged parallel to each other, a doctor blade 52Y, and a toner density sensor (hereinafter, “T sensor”) 56Y.

The Y developer (not shown) that contains the magnetic carriers and the Y toners is accommodated in the casing of the developing device 5Y. The two conveyer screws 55Y convey the Y developer to the surface of the developing roller 51Y, while agitating the Y developer so that the Y developer is charged due to friction and thus the charged Y developer is attached onto the surface of the developing roller 51Y. The doctor blade 52Y shapes the Y developer lying on the developing roller 51Y into a layer with a fixed thickness. After that, when the Y developer is conveyed to a developing area lying opposite to the photosensitive element 1Y for Y, the Y toners are attached to the electrostatic latent image formed on the photosensitive element. In this manner, the Y toner image is formed on the photosensitive element 1Y. The residual Y developer with a less amount of the Y toners returns back to the casing with the rotation of the developing roller 51Y.

A partition is provided between the two conveyer screws 55Y. The casing is separated by the partition into a first supply chamber 53Y that accommodates the developing roller 51Y and the first conveyer screw 55Y that is arranged on the right side of FIG. 2 and a second supply chamber 54Y that accommodates the second conveyer screw 55Y that is arranged on the left side of FIG. 2. The first conveyer screw 55Y rotates by a force of a driving unit (not shown) and conveys the Y developer in the direction perpendicular to the sheet surface of FIG. 2 from the near side to the far side in the first supply chamber 53Y, thereby supplying the Y developer to the developing roller 51Y. After the Y developer is conveyed near the end of the first supply chamber 53Y by the first conveyer screw 55Y, the Y developer is conveyed into the second supply chamber 54Y through an opening (not shown) of the partition. In the second supply chamber 54Y, the second conveyer screw 55Y rotates by a force of a driving unit (not shown) and conveys the Y developer coming from the first supply chamber 53Y in the direction reverse to the conveying direction of the first conveyer screw 55Y. After the Y developer is conveyed near the end of the second supply chamber 54Y by the second conveyer screw 55Y, the Y developer is conveyed back into the first supply chamber 53Y through another opening (not shown) of the partition.

The T sensor 56Y includes a permeability sensor. The T sensor is arranged on the bottom side of the second supply chamber 54Y and outputs a voltage corresponding to the permeability of the Y developer passing on the T sensor. The permeability of the two-component developer, which contains toners and magnetic carriers, is correlated to the toner density; therefore, the T sensor 56Y outputs the voltage corresponding to the Y toner density. The value of the output voltage is sent to a control unit (not shown). The control unit includes a random access memory (RAM) that stores therein a target value Vtref for Y that is the target value of the output voltage received from the T sensor 56Y. The RAM stores therein various target values of the output voltages received from the other T sensors (not shown) included in the other developing devices, such as Vtref for C, Vtref for M, and Vtref for K. The target value Vtref for Y is used to control the Y-toner conveying device. Specifically, the control unit controls the Y-toner conveying device so that the value of the output voltage received from the T sensor 56Y comes closer to the target value Vtref for Y and causes the Y-toner conveying device to supply the Y toners into the second supply chamber 54Y. With this configuration, the Y-toner density of the Y developer in the developing device 5Y is always in a certain range. The same toner supply control is implemented over the developing devices of the other process units for C, M, and K using a C-toner conveying device, an M-toner conveying device, and a K-toner conveying device.

Referring back to FIG. 1, an optical writing unit 7 is arranged under the process units 6Y, 6C, 6M, and 6K. The optical writing unit 7, which corresponds to a latent-image writing device, irradiates and exposes the photosensitive element of each of the process units 6Y, 6C, 6M, and 6K with and to the laser light L generated based on image data. As a result, the Y, C, M, and K electrostatic latent images are formed on the photosensitive elements 1Y, 1C, 1M, and 1K. In the optical writing unit 7, a polygon mirror that is rotating by a force of a motor scans the laser light L emitted from a light source. The laser light L passes through a plurality of optical lenses and mirrors and then irradiates the photosensitive element.

A paper supply unit that includes a paper cassette 26 and a paper-feed roller 27 is arranged under the optical writing unit 7. The paper cassette 26 accommodates a plurality of recording sheets P in a stacked state. The leading edge of the top recording sheets P is in contact with the paper-feed roller 27. When the paper-feed roller 27 rotates in the counter-clockwise direction by a force of a driving unit (not shown), the top recording sheet P is fed to a paper feed path 70.

A pair of registration rollers 28 is arranged near the end of the paper feed path 70. The registration rollers 28 rotate and pull the recording sheet P into therebetween. Immediately after the recording sheet P is inserted between the registration rollers 28, the rotation of the registration rollers 28 stops. After that, the registration rollers 28 convey the recording sheet P at the appropriate timing toward a later-described secondary transfer nip.

A transfer unit 15, in which the intermediate transfer belt 8 rotates in a supported state, is arranged above the process units 6Y, 6C, 6M and 6K. The transfer unit 15 includes the intermediate transfer belt 8, a secondary-transfer bias roller 19, a belt cleaning device 10, primary-transfer bias rollers 9Y, 9C, 9M and 9K, a driving roller 12, a cleaning backup roller 13, a driven roller 14, and a supporting roller 11. The intermediate transfer belt 8 is rotated in the counter-clockwise direction by rotation of the driving roller 12 while being supported by these rollers. The primary-transfer bias rollers 9Y, 9C, 9M and 9K make primary-transfer nips with the photosensitive elements 1Y, 1C, 1M, and 1K, respectively in such a manner that the rotating intermediate transfer belt 8 is inserted into the primary-transfer nips. The back surface of the intermediate transfer belt 8 (i.e., the inner circumferential surface of the loop) is charged with a bias opposite to a bias (e.g., plus) with which the toners are charged. All the rollers other than the primary-transfer bias rollers 9Y, 9C, 9M and 9K are grounded. When the intermediate transfer belt 8 rotates, sequentially passing through the primary-transfer nips for Y, C, M and K, the Y, C, M and K toner images are transferred from the photosensitive elements 1Y, 1C, 1M, and 1K onto the intermediate transfer belt 8 in a superimposed manner (primary transfer). Thus, the four-color superimposed toner image (hereinafter, “four-color toner image”) is formed on the intermediate transfer belt 8.

The driving roller 12, which is a driving rotary member, makes a secondary-transfer nip with the secondary-transfer bias roller 19 in such a manner that the rotating intermediate transfer belt 8 is inserted into the secondary-transfer nip. The visible four-color toner image that is formed on the intermediate transfer belt 8 is transferred onto the recording sheet P at the secondary-transfer nip. The four-color toner image and the white recording sheet P join together, which forms a full-color toner image. A part of the toners remains on the intermediate transfer belt 8 without being transferred to the recording sheet P at the secondary-transfer nip. The residual toners are removed from the intermediate transfer belt 8 by the belt cleaning device 10. The recording sheet P that has received the four-color toner image is conveyed to a fixing device 20 via a post-transfer conveyer path 71.

The fixing device 20 includes a fixing roller 20a that has a heat source, such as a halogen lamp, inside and a pressure roller 20b that rotates while being in contact with the fixing roller 20a by a certain pressure. The fixing roller 20a and the pressure roller 20b together make a fixing nip. In the fixing device 20, the recording sheet P is inserted into the fixing nip in such a manner that the surface on which the unfixed toner image is placed comes into tight contact with the fixing roller 20a. The toners of the toner image are softened due to the heat and pressure and thus the full-color image is fixed to the recording sheet P.

After passed through the fixing device 20, the recording sheet P with the fixed full-color image comes to a bifurcation point that leads to either a sheet discharge path 72 or a pre-reverse conveyer path 73. A claw 75 is arranged at the bifurcation point and a direction in which the recording sheet P is conveyed is determined by the swing of the claw 75. Specifically, if the tip of the claw 75 moves closer to the pre-reverse conveyer path 73, the recording sheet P is conveyed to the sheet discharge path 72. If the tip of the claw 75 moves away from the pre-reverse conveyer path 73, the recording sheet P is conveyed to the pre-reverse conveyer path 73.

If the path to the sheet discharge path 72 is selected by the swing of the claw 75, the recording sheet P is conveyed along the sheet discharge path 72 through a pair of discharge rollers 100 and then discharged out of the printer. The recording sheet P is stacked on a stacker 50a that is located on the upper surface of the casing of the printer. In contrast, if the path to the pre-reverse conveyer path 73 is selected by the swing of the claw 75, the recording sheet P is conveyed along the pre-reverse conveyer path 73 and then inserted into a nip between a pair of reverse rollers 21. The reverse rollers 21 rotate forward and convey the recording sheet P toward the stacker 50a and then rotate rearward immediately before the trailing edge of the recording sheet P comes into the nip. By the rearward rotation, the recording sheet P is conveyed reversely and the trailing edge of the recording sheet is conveyed into a reverse conveyer path 74.

The reverse conveyer path 74 extends from the upper side to the lower side in the vertical direction along a curved line. Along the reverse conveyer path 74, a pair of first reverse conveyer rollers 22, a pair of second reverse conveyer rollers 23, and a pair of third reverse conveyer rollers 24 are arranged. The recording sheet P sequentially passes between these pairs of the rollers and turns upside down. The upside-down recording sheet P comes back to the paper feed path 70 and then comes into the secondary-transfer nip. The recording sheet P passes through the secondary-transfer nip in such a manner that the surface having no image comes into tight contact with the intermediate transfer belt 8 and receives another four-color toner image from the intermediate transfer belt 8 onto the surface having no image. After that, the recording sheet P is conveyed along the post-transfer conveyer path 71, the sheet discharge path 72, and the discharge rollers 100, discharged out of the printer, and then stacked on the stacker 50a. In this manner, the full-color images are formed on both surfaces of the recording sheet P.

A bottle supporting unit 31 is arranged between the transfer unit 15 and the stacker 50a with the stacker 50a being the highest. The bottle supporting unit 31 supports toner accommodating units, i.e., a toner bottle 32Y that accommodates the Y toners, a toner bottle 32C that accommodates the C toners, a toner bottle 32M that accommodates the M toners, and a toner bottle 32K that accommodates the K toners. The toner bottles 32Y, 32C, 32M, and 32K are aligned along a line slightly incline to the horizontal line in this order with the toner bottle 32Y being the highest level. The Y, C, M and K toners are supplied to the developing devices included in the process units 6Y, 6C, 6M and 6K as appropriately by the toner conveying devices. The toner bottles 32Y, 32C, 32M, and 32K are detachable from the main body of the printer independently from the process units 6Y, 6C, 6M and 6K.

In the printer according to the present embodiment, the arrangement of the photosensitive elements with respect to the intermediate transfer belt 8 in the monochrome mode, in which a monochrome image is formed, is different from the arrangement in the color mode, in which a color image is formed. Specifically, the primary-transfer bias roller 9K is supported by a dedicated bracket (not shown), while the other primary-transfer bias rollers 9Y, 9C, and 9M are supported by common a movable bracket (not shown). The movable bracket moves, in accordance with operations of a solenoid (not shown), close to and away from the photosensitive elements 1Y, 1C, and 1M. When the movable bracket moves away from the photosensitive elements 1Y, 1C, and 1M, the loop shape of the intermediate transfer belt 8 is deformed and the intermediate transfer belt 8 moves away from the three photosensitive elements 1Y, 1C, and 1M. The photosensitive element 1K remains in contact with the intermediate transfer belt 8. In the monochrome mode, an image is formed in the situation where only the photosensitive element 1K is in contact with the intermediate transfer belt 8. During the image forming process in the monochrome mode, the photosensitive element 1K keeps rotating, while the other photosensitive elements 1Y, 1C, and 1M are stopped.

When the movable bracket moves close to the three photosensitive elements 1Y, 1C, and 1M, the loop shape of the intermediate transfer belt 8 is deformed and the intermediate transfer belt 8, which has been away from the three photosensitive elements 1Y, 1C, and 1M, comes into contact with the three photosensitive elements 1Y, 1C, and 1M. The photosensitive element 1K is always in contact with the intermediate transfer belt 8. In the color mode, an image is formed in the situation where all the four photosensitive elements 1Y, 1C, 1M, and 1K are in contact with the intermediate transfer belt 8. With this configuration, the movable bracket and the solenoid together work as a moving unit that moves the intermediate transfer belt 8 close to and away from the photosensitive elements.

The printer according to the present embodiment includes a main control unit (not shown) that corresponds to a control unit that controls the four process units 6Y, 6C, 6M and 6K, the optical writing unit 7, etc. The main control unit includes a central processing unit (CPU) that is a calculating unit, a RAM that is a data storage unit, and a read only memory (ROM) that is a data storage unit. The main control unit controls the process units and the optical writing unit on the basis of computer programs stored in the ROM.

The printer includes a driving control unit (not shown) separated from the main control unit. The driving control unit includes a CPU, a ROM, and a nonvolatile RAM that is a data storage unit. The driving control unit controls a shared driving motor and photosensitive-element motors, which will be described in detail later, on the basis of computer programs stored in the ROM.

FIG. 3 is a perspective view showing the process unit 6Y for Y, which is detachable from the main body of the printer, and a photosensitive-element gear 151Y for Y, which is attached to the main body of the printer. As shown in FIG. 3, the photosensitive-element gear 151Y is supported rotatably inside the main body of the printer. The process unit 6Y is detachable from the main body of the printer. The photosensitive element 1Y of the process unit 6Y has a cylindrical drum member and two shaft members. The two shaft members protrude in the rotation axis direction from both end surfaces of the cylindrical drum member and from the unit casing. One of the shaft members arranged on the far side of FIG. 3 (not shown) is fixed to a well-known coupling. A coupling member 152Y is formed near the rotation axis of the photosensitive-element gear 151Y arranged on the main-body side. The coupling member 152Y is connected to the coupling that is fixed to the shaft member of the photosensitive element 1Y. With this connection, the rotation of the photosensitive-element gear 151Y is transmitted to the photosensitive element 1Y via the coupling connection. When the process unit 6Y is pulled out from the main body of the printer, the coupling that is fixed to the shaft member of the photosensitive element 1Y is decoupled from the coupling member 152Y that is formed on the photosensitive-element gear 151Y. Although the configuration of the process unit 6Y for Y, such as the connection between the photosensitive element 1Y and the photosensitive-element gear 151Y and the mechanism of the decoupling, has been described, the other process units have the same configuration.

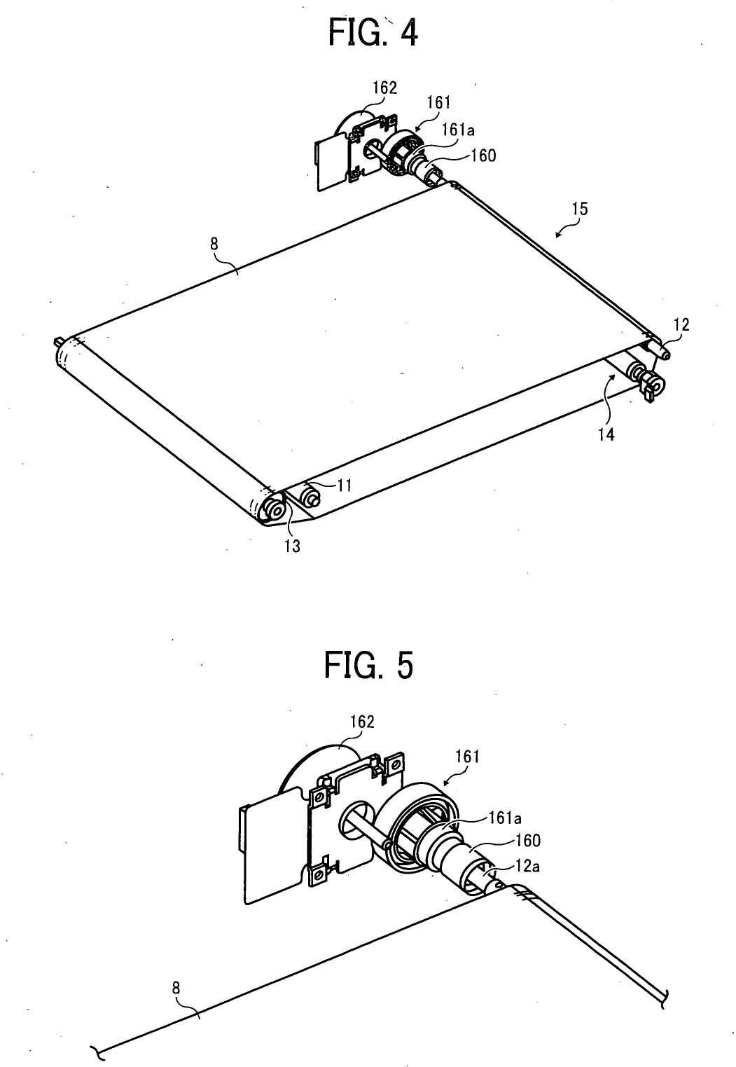

FIG. 4 is a perspective view showing the transfer unit 15 and a motor that drives the intermediate transfer belt. FIG. 5 is an enlarged perspective view showing the motor and the components nearby. As shown in FIGS. 4 and 5, a coupling 160 is fixed to a rotation-axial end of a shaft member 12a of the driving roller 12 that rotates the intermediate transfer belt 8 by the rotation thereof. A belt-driving transmission gear 161 is rotatably supported inside the main body of the printer. A coupling member 161a is formed at the center of the belt-driving transmission gear 161. The transfer unit 15 is detachable from the main body of the printer. FIGS. 4 and 5 illustrate the transfer unit 15 in the attached state arranged inside the main body of the printer. When the transfer unit 15 is in the attached state, the coupling 160, which is fixed to the driving roller 12 of the transfer unit 15, is connected to the coupling member 161a of the belt-driving transmission gear 161, which is supported inside the main body of the printer, in the direction of the axis. When the transfer unit 15 is pulled out of the main body of the printer, the coupling 160, which is fixed to the driving roller 12 of the transfer unit 15, is disconnected from the coupling member 161a of the belt-driving transmission gear 161, which is supported inside the main body of the printer.

A shared driving motor 162 is a DC servomotor that is fixed inside the main body of the printer near the belt-driving transmission gear 161. A motor gear of the shared driving motor 162 is engaged with the belt-driving transmission gear 161. When the shared driving motor 162 rotates, the rotation is transmitted to the intermediate transfer belt 8 via the belt-driving transmission gear 161, the coupling connection, and the driving roller 12.

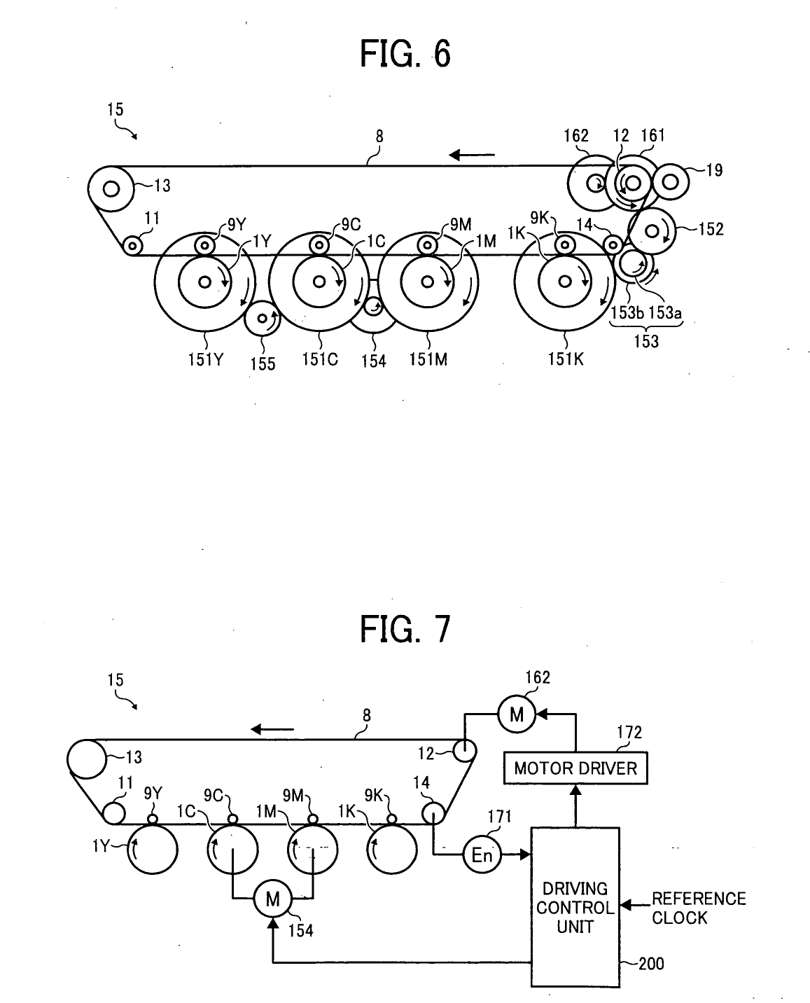

FIG. 6 is a schematic diagram showing the transfer unit 15, the photosensitive elements 1Y, 1C, 1M, and 1K, and the gears supported inside the main body of the printer. As shown in FIG. 6, various gears, such as the photosensitive-element gear 151Y for Y, a photosensitive-element gear 151C for C, a photosensitive-element gear 151M for M, and a photosensitive-element gear 151K for K, the belt-driving transmission gear 161, a first transmission gear 152, a second transmission gear 153, and a third transmission gear 155, are supported rotatably inside the main body of the printer. The first transmission gear 152 and the second transmission gear 153 transmit a driving force to the photosensitive-element gear 151K. The third transmission gear 155 transmits a driving force to the photosensitive-element gear 151Y. A color photosensitive-element motor 154, which works as an image-carrier driving force, is arranged in a fixed manner.

The belt-driving transmission gear 161 is engaged with not only the motor gear of the shared driving motor 162 but also the first transmission gear 152. The second transmission gear 153 that includes an input gear member 153a and an output gear member 153b arranged coaxially to each other is arranged near the first transmission gear 152. The first transmission gear 152 is engaged with the input gear member 153a of the second transmission gear 153. The output gear member 153b of the second transmission gear 153 is engaged with the photosensitive-element gear 151K for K. With this gear arrangement, the rotation of the shared driving motor 162 is transmitted, via the belt-driving transmission gear 161, the first transmission gear 152, the second transmission gear 153, and the photosensitive-element gear 151K for K, to the photosensitive element 1K for K. In other words, in the printer according to the present embodiment, the shared driving motor 162 works as not only the belt driving source that drives both the driving roller 12 and the intermediate transfer belt 8 but also the driving source of the photosensitive element for K, i.e., an image-carrier driving source.

In contrast, the photosensitive elements 1Y, 1C, and 1M are driven by a driving source different from the shared driving motor 162. Specifically, the motor gear of the color photosensitive-element motor 154, which works as an image-carrier driving source that is fixed inside the main body of the printer, is arranged between the photosensitive-element gear 151C for C and the photosensitive-element gear 151M for M. The motor gear of the color photosensitive-element motor 154 is engaged with these gears. With this configuration, the motor gear of the color photosensitive-element motor 154 is designed to transmit force directly to both the photosensitive-element gear 151C for C and the photosensitive-element gear 151M for M.

The third transmission gear 155, which is supported rotatably by the main body of the printer, is arranged between the photosensitive-element gear 151Y for Y and the photosensitive-element gear 151C for C and engaged with these gears. The third transmission gear 155 transmits the rotation of the photosensitive-element gear 151C for C to the photosensitive-element gear 151Y for Y.

FIG. 7 is a schematic diagram showing a driving control unit 200 and components that are electrically connected to the driving control unit 200. The linear speed of the driven roller 14, which is a supporting member that is arranged inside the loop of the intermediate transfer belt 8 pushing the loop outward to support the belt and is rotated by the rotation of the belt, is equal to the linear speed of the intermediate transfer belt 8. Therefore, the angular velocity or the angular displacement of the rotating driven roller 14 indirectly indicates the moving speed of the rotating intermediate transfer belt 8. A roller encoder 171 that is a rotary encoder is fixed to a shaft member of the driven roller 14. The roller encoder 171 detects the angular velocity or the angular displacement of the rotating driven roller 14 and outputs the detected result to the driving control unit 200. The roller encoder 171 works as a speed-fluctuation detecting unit that detects a fluctuation in the moving speed of the intermediate transfer belt 8 caused by a diameter change of the driving roller 12 due to temperature change. Moreover, the roller encoder 171 works as a speed detecting unit that detects the moving speed of the rotating intermediate transfer belt 8. The driving control unit 200 obtains information about the fluctuation or the moving speed of the intermediate transfer belt 8 using the detected result received from the roller encoder 171.

Although, in the printer according to the present embodiment, the roller encoder 171 that detects the angular velocity or the angular displacement of the driven roller 14 is used as the speed-fluctuation detecting unit and the speed detecting unit, some other devices that detect the fluctuation and the moving speed with some other methods may be used. For example, it is allowable to form a plurality of marks at equal pitches on the intermediate transfer belt in the circumferential direction, detect the marks using an optical sensor, and detect the fluctuation and the moving speed of the belt by measuring intervals between the times at which the marks are detected (see Japanese Patent Application Laid-open No. 2004-220006). Moreover, it is allowable to use an optical image sensor that is used in an input device of a personal computer, such as an optical mouse, as the speed-fluctuation detecting unit or the speed detecting unit. Furthermore, the printer may detect the temperature inside the printer using a temperature sensor and a detecting unit that predicts the belt moving speed using the detected temperature and the relation between the temperature and the thermally expanded amount of the driving roller 12 may be provided.

During the continuous printing operation in which a series of images are recorded on a plurality of the recording sheets P, as the temperature inside the printer increases with the passage of time, the diameter of the driving roller 12 gradually increases. As the temperature inside the printer decreases after the end of the continuous printing operation, the diameter of the driving roller 12 gradually decreases. If V is the linear speed of the intermediate transfer belt 8, r is the radius of the driving roller 12, and ω is the angular velocity of the driving roller 12, then “V=rω” is satisfied. Therefore, if the angular velocity ω is fixed, i.e., the driving speed of the shared driving motor 162 is constant, the linear speed V of the intermediate transfer belt 8 changes as the diameter of the driving roller 12 changes. The change in the linear speed V causes misalignment of the toner images.

To prevent the misalignment, the driving control unit 200 performs a PLL control, i.e., adjusts the driving speed of the shared driving motor 162 to synchronize the pulse signal received from the roller encoder 171 with the frequency of the reference clock. With this control, when the driven roller 14 provided with the roller encoder 171 rotates at the constant angular velocity, the moving speed of the intermediate transfer belt 8 is fixed to the predetermined speed. In other words, by means of the control over the driving speed of the shared driving motor 162 based on the fluctuation and the moving speed of the intermediate transfer belt 8, the intermediate transfer belt 8 can rotate at the predetermined moving speed, regardless of the diameter change of the driving roller 12.

A motor driver 172 that works as a driving circuit that drives the shared driving motor 162 (DC servomotor) in the servo system can change the proportional gain on the basis of the signal received from the driving control unit 200 using a well-known method.

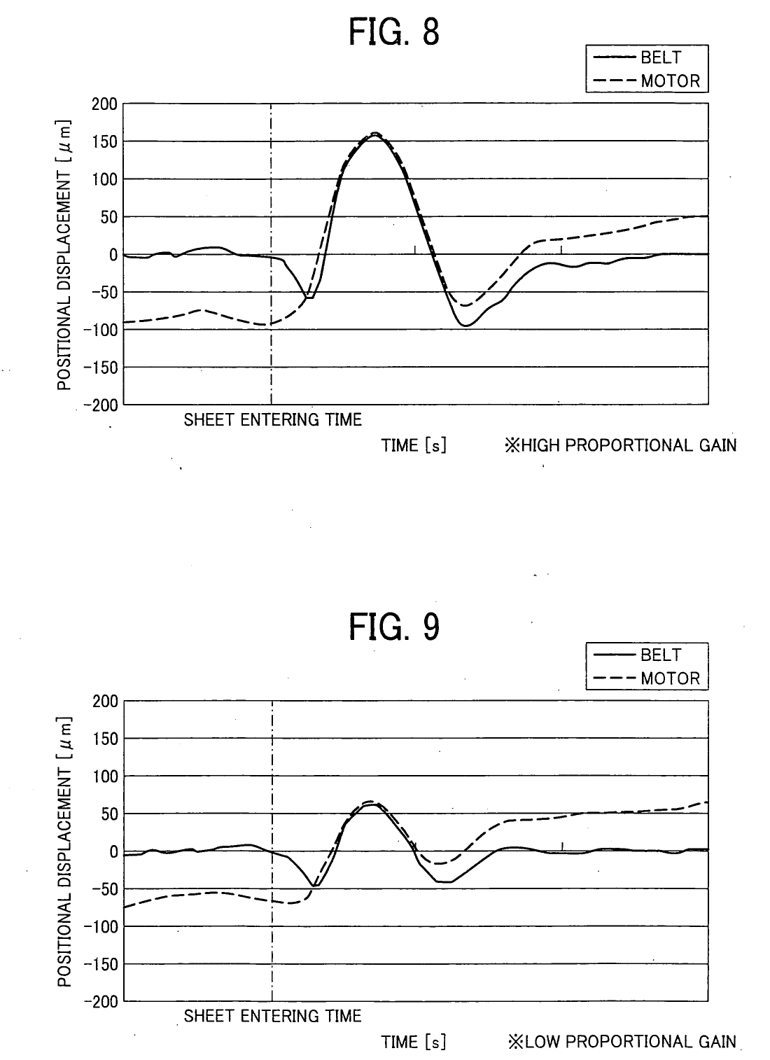

FIG. 8 is a graph that explains a relation between the positional displacements (i.e., fluctuation in the moving speed) of the belt and the motor at the sheet entering time and the elapsed time when the proportional gain of the motor driver 172 is set relatively high. FIG. 9 is a graph that explains a relation between the positional displacements (i.e., fluctuation in the moving speed) of the belt and the motor at the sheet entering time and the elapsed time when the proportional gain of the motor driver 172 is set relatively low. As it is clear from these graphs that when the proportional gain of the motor driver 172 is set relatively low, when compared with the case where the proportional gain is set relatively high, the amount of the overshoot in the belt moving speed immediately after the sheet entering time is reduced. This is because as the proportional gain decreases, the responsiveness of the shared driving motor 162 (DC servomotor) to the fluctuation in the rotation speed decreases.

When the monochrome mode is selected, the driving control unit 200 shown in FIG. 7 sets the proportional gain of the motor driver 172 lower than the value set in the color mode. With this configuration, the amount of the overshoot in the belt moving speed at the sheet entering time in the monochrome mode is reduced, which suppresses the distortion of the image due to overshoot.

In contrast, in the color mode, in which all the photosensitive elements are in contact with the intermediate transfer belt 8, if the proportional gain of the motor driver 172 is not high enough, it is impossible to adjust the driving speed appropriately in accordance with short-period fluctuation in the belt moving speed, such as a fluctuation in the belt moving speed having the roller rotation period caused by the decentered driving roller. To settle the problem, the printer according to the first embodiment sets, if the color mode is selected, the proportional gain high enough to adjust the moving speed appropriately in accordance with the short-period fluctuation in the belt moving speed.

Printers according to some examples of the first embodiment are described below. The following printers have their characteristic configurations but are based on the printer according to the first embodiment.

A printer according to a first example can switch, according to an instruction received from a user, between high-speed mode, in which an image is formed with the intermediate transfer belt 8 and the photosensitive elements being moved at relatively high speeds, and low-speed mode, in which an image is formed with the intermediate transfer belt 8 and the photosensitive elements being moved at relatively low speeds.

The temporal decrease in the moving speed of the intermediate transfer belt 8 at the sheet entering time in the high-speed mode is larger than the temporal decrease in the low-speed mode. Accordingly, the overshoot in the belt moving speed immediately after the sheet entering time in the high-speed mode is larger than the overshoot in the low-speed mode. When the printer according to the first example is in the low-speed mode, the amount of the overshoot in the belt moving speed occurring at the sheet entering time is not so large. In contrast, if the printer is in the high-speed mode, a large overshoot occurs in the monochrome mode.

To prevent large overshoot, if the monochrome mode is selected in the low-speed mode, the driving control unit 200 sets the proportional gain of the motor driver 172 to the value equal to the value set in the color mode. If the monochrome mode is selected in the high-speed mode, the driving control unit 200 sets the proportional gain of the motor driver 172 to a value lower than the value set in the color mode. With this configuration, even if the monochrome mode is selected, if the amount of the overshoot at the sheet entering time is expected to be small enough, the proportional gain is set relatively large, which maintains the high responsiveness of the shared driving motor 162 to the driving speed.

When a thick sheet is used as the recording sheet P, the amount of the temporal decrease in the moving speed of the intermediate transfer belt 8 at the sheet entering time is large as compared with the case that a thin sheet is used. The amount of the overshoot immediately after the sheet entering time is large as compared with the case that the thin sheet is used. When a printer according to a second example is in the low-speed mode and the recording sheet P is thin, a large overshoot does not occur. However, if the thickness of the recording sheet P exceeds a threshold, a large overshoot occurs in the monochrome mode.

To prevent a large overshoot, the printer according to the second example includes a thickness-information obtaining unit that obtains information about the thickness of the recording sheet P before the recording sheet P enters the secondary transfer nip. Although a variety of methods can be taken as the method of obtaining the thickness-information, the printer according to the present example uses a thickness detecting unit that detects the thickness. Although there are a variety of thickness detecting units, the printer according to the present example uses a thickness detecting unit that detects the thickness using the driving current of a certain motor. The motor drives at least one of two conveyer rollers that are arranged with their surfaces coming into contact with each other so as to hold the recording sheet P therebetween and convey the recording sheet P. After a driving-current detecting unit detects the driving current of the motor, the thickness detecting unit detects the thickness of the recording sheet P using the detected result. Alternatively, it is allowable to detect an amount of displacement of one of the rollers and detect the thickness of the recording sheet P using the detected displacement. Further alternatively, it is allowable to detect the thickness of the recording sheet P using the light transmittance of the sheet. Furthermore, it is allowable to obtain the information about the thickness by means of an input operation by a user.

If, in the monochrome mode, the thickness indicated by the information that is obtained by the thickness-information obtaining unit is smaller than the threshold, the proportional gain of the motor driver 172 is set the value equal to the value set in the color mode. In contrast, if the thickness exceeds the threshold, the proportional gain of the motor driver 172 is set a value lower than the value set in the color mode. With this configuration, when the monochrome mode is selected and the amount of the overshoot at the sheet entering time is expected to be small enough, the proportional gain is set relatively large, which maintains the high responsiveness of the shared driving motor 162 to the driving speed.

Even if the recording sheets with the same thickness are used, the amount of the overshoot slightly varies depending on the material. To adjust the slight difference, the printer according to the present example includes a threshold changing unit that changes the threshold to a value specified by means of an input operation. With this configuration, the printer can deal with a variety of recording sheets with different materials in an appropriate manner.

A printer according to a second embodiment of the present invention is described below. The configuration of the printer according to the second embodiment is the same as the configuration of the printer according to the first embodiment otherwise specified in the following description.

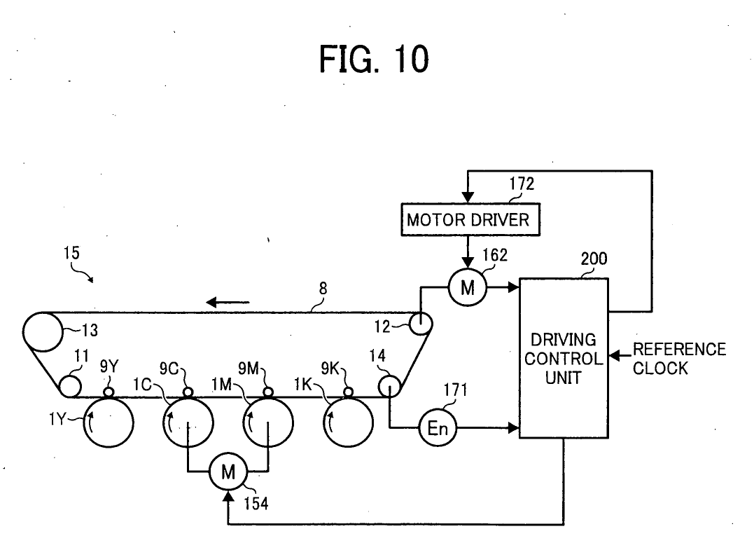

FIG. 10 is a schematic diagram showing the driving control unit 200 and components that are electrically connected to the driving control unit 200 according to the second embodiment. When the color mode is selected, the driving control unit 200 adjusts the shared driving motor 162 using the detected result obtained by the roller encoder 171 as the feedback in the same manner as in the first embodiment. When the monochrome mode is selected, in contrast, the shared driving motor 162 is adjusted using a rotation signal (angular velocity signal) output from the shared driving motor so that the shared driving motor 162 rotates at a constant angular velocity.

As shown in FIG. 8, when the recording sheet enters the transfer nip, both the belt moving speed and the motor rotation speed decrease; however, the rate of the decrease of the motor rotation speed is smaller than the rate of the decrease of the belt moving speed. Therefore, if the shared driving motor 162 is adjusted, on the basis of the rotation signal (angular velocity signal) output from the shared driving motor, to rotate at the constant angular velocity, the amount of the overshoot in the belt moving speed at the sheet entering time is reduced when compared with the adjustment based on the detected result of the roller encoder 171, which suppresses the distortion of the image due to overshoot.

It should be noted that, if the shared driving motor 162 is adjusted to rotate at the constant angular velocity, the belt moving speed will deviate from the target speed as the diameter of the driving roller changes with the passage of the time. If the belt moving speed deviates from the target speed, in the monochrome mode, no color shift occurs but a slightly elongated or contracted image is formed. Accordingly, from the perspective of the high quality, the configuration of the printer according to the first embodiment is preferable.

According to these embodiments of the present invention, a single motor is configured to drive an intermediate transfer belt and at least one image carrier of a plurality of image carriers, which reduces manufacturing costs. Moreover, if the color mode is selected, it is configured to detect a fluctuation in the moving speed of the intermediate transfer belt and adjust the driving speed of the motor on the basis of the detected fluctuation. With this configuration, the intermediate transfer belt can rotate at the target speed even if the diameter of the driving rotary member changes with the passage of the time and thus the occurrence of a color shift is suppressed.

Furthermore, in an embodiment that satisfies all the elements described in claim 1, if the single-color mode is selected, the proportional gain of a motor driving circuit is set to a value lower than a value that is set in the color mode. As a result, the responsiveness of the servomotor to the fluctuation in the rotation speed decreases and, therefore, the amount of overshoot in the belt moving speed at the sheet entering time is reduced, which suppresses the distortion of the image due to overshoot.

Moreover, in an embodiment that satisfies all the elements described in claim 5, if the single-color mode is selected, the motor is adjusted to run at a constant angular velocity. When a recording sheet comes into the transfer nip, both the belt moving speed and the motor rotation speed decrease; however, the rate of the decrease of the motor rotation speed is smaller than the rate of the decrease of the belt moving speed. This is because, during the time when the temporal load fluctuation is transmitted from the intermediate transfer belt to the motor via the driving-force transmission system, a part of the fluctuation in the temporal load is absorbed by, for example, the belt and the gears due to changes in the belt tension or the gears rattling. Accordingly, the amount of the overshoot in the belt moving speed at the sheet entering time is reduced when compared with the case of setting the belt to a constant moving speed, which suppresses the distortion of the image due to overshoot.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a plurality of image carriers that rotate with different-color visual images carried on their surfaces;
a plurality of image-carrier driving sources that drive the image carriers;
an intermediate transfer belt that rotates in a state supported by a plurality of supporting members;
a driving rotary member that is one of the supporting members and rotates the intermediate transfer belt by rotation thereof;
a speed-fluctuation detecting unit that detects fluctuation in moving speed of the intermediate transfer belt;
a driving control unit; and
a transfer unit that transfers the different-color visual images from the surfaces of the image carriers onto a surface of the intermediate transfer belt and then transfers the transferred image onto a recording sheet, wherein
one of the image-carrier driving sources that corresponds to a specific color is a servomotor, and the servomotor also works as a belt driving source that is a driving source of the driving rotary member,
the driving control unit controls driving speed of the belt driving source on the basis of a detected result obtained by the speed-fluctuation detecting unit,
a driving circuit of the servomotor includes a gain changing unit that changes proportional gain, and
when a single-color mode, in which an image is formed with only the specific color, is selected, the driving control unit sets the proportional gain lower than a value that is set in a color mode, in which a full-color image is formed by superimposing a plurality of different-color visual images.

2. The image forming apparatus according to claim 1, wherein
the image forming apparatus is configured to be switched, according to an instruction received from a user, between a high-speed mode, in which an image is formed with the intermediate transfer belt being moved at a relatively high driving speed, and a low-speed mode, in which an image is formed with the intermediate transfer belt being moved at a relatively low driving speed, and
when the single-color mode is selected in the high-speed mode, the driving control unit sets the proportional gain lower than the value that is set in the color mode.

3. The image forming apparatus according to claim 1, further comprising a thickness-information obtaining unit that obtains thickness information of the recording sheet to be conveyed to the transfer unit, wherein
when the single-color mode is selected and the thickness information obtained by the thickness-information obtaining unit is equal to or larger than a threshold, the driving control unit sets the proportional gain lower than the value that is set in the color mode.

4. The image forming apparatus according to claim 3, further comprising a threshold changing unit that changes the threshold in accordance with an instruction by an operator.

5. An image forming apparatus comprising:
a plurality of image carriers that rotate with different-color visual images carried on their surfaces;
a plurality of image-carrier driving sources that drive the image carriers;
an intermediate transfer belt that rotates in a state supported by a plurality of supporting members;
a driving rotary member that is one of the supporting members and rotates the intermediate transfer belt by rotation thereof;
a speed-fluctuation detecting unit that detects fluctuation in moving speed of the intermediate transfer belt;
a driving control unit; and
a transfer unit that transfers the different-color visual images from the surfaces of the image carriers onto a surface of the intermediate transfer belt and then transfers the transferred image onto a recording sheet, wherein
one of the image-carrier driving sources that corresponds to a specific color is a motor that includes a rotation-signal output unit, and the motor also works as a belt driving source that is a driving source of the driving rotary member,
when a color mode, in which a full-color image is formed by superimposing a plurality of different-color visual images, is selected, the driving control unit controls driving speed of the motor on the basis of a detected result obtained by the speed-fluctuation detecting unit, and
when a single-color mode, in which an image is formed with only the specific color, is selected, the driving control unit controls the motor on the basis of a rotation signal output from the motor so that the motor runs at a constant angular velocity.
